(19) United States
(12) Patent Application Publication
(10) Pub. No.: US 2026/0307729 A1
(43) Pub. Date: Oct. 8, 2026

(54) ROOF STRUCTURE FOR VEHICLE

(71) Applicants: Hyundai Motor Company, Seoul (KR); Kia Corporation, Seoul (KR)

(72) Inventors: Byeongkyu Kwon, Hwaseong-si (KR); Hoyeon Kim, Hwaseong-si (KR); Chulhee Heo, Hwaseong-si (KR); Hae Hoon Lee, Hwaseong-si (KR)

(21) Appl. No.: 19/423,396

(22) Filed: Dec. 17, 2025

(30) Foreign Application Priority Data
Apr. 2, 2025 (KR) 10-2025-0042553
Jun. 5, 2025 (KR) 10-2025-0073504

(51) Int. Cl. B62D 25/06; B62D 63/02

(52) U.S. Cl. CPC B62D 25/06; B62D 63/025

(57) ABSTRACT

A roof structure may include a roof panel, transverse direction roof rails connected to a lower portion of the roof panel and disposed along a vehicle width direction, longitudinal direction roof rails connected to the transverse direction roof rails along a vehicle front-rear direction and connected to a lower portion of the roof panel, and a reinforcement member connected to a cross joint portion of the transverse direction roof rails and the longitudinal direction roof rails.

### CROSS-REFERENCE TO RELATED APPLICATION

This application claims priority to and the benefit of Korean Patent Application No. 10-2025-0042553 filed with the Korean Intellectual Property Office on Apr. 2, 2025, and Korean Patent Application No. 10-2025-0073504 filed with the Korean Intellectual Property Office on Jun. 5, 2025, the entire contents of which are incorporated herein by reference.

### TECHNICAL FIELD

The present disclosure relates to a roof structure applicable to the production of various vehicle bodies.

### BACKGROUND

Recently, the vehicle industry has been introducing a new concept of future mobility vision for realizing a dynamic, human-centered future city. One of these future mobility solutions is a purpose-based mobility (Purpose Built Vehicle; PBV).

PBV is an example of an electric vehicle (EV)-based environment-friendly mobility vehicle. These PBVs can provide users with a variety of customized services during their travel from departure to destination.

PBV can be manufactured in various shapes and sizes depending on the user’s use case. For example, PBV can be used as a hailing or delivery type (or cargo type) vehicle.

PBV applies large-area roof panels to various vehicle types to provide users with a wide vehicle interior space according to their various use cases.

However, as large-area roof panels are applied to the vehicle body, the connection of the roof rails and the bonding strength of the roof panels may become weak, such as the roof rails sagging.

The information contained in this background section is intended to enhance understanding of the background of the present disclosure and may include matters that are not conventional art already publicly known, available, or in use.

### SUMMARY

The disclosed example embodiments relate to a vehicle body, and more particularly, the present disclosure relates to a roof structure applicable to the production of various vehicle bodies.

Embodiments of the present disclosure can provide a roof structure that can provide a wide vehicle interior space to a vehicle body of various vehicle types and can enhance the bonding strength of the roof panels.

A roof structure according to some embodiments of the present disclosure may include: transverse direction roof rails connected to a lower portion of a roof panel and disposed along a vehicle width direction; longitudinal direction roof rails connected to the transverse direction roof rails along a front-rear direction of the vehicle body and connected to a lower portion of the roof panel; and a reinforcement member connected to a cross joint portion of the transverse direction roof rails and the longitudinal direction roof rails.

The longitudinal direction roof rails may be connected to a front transverse direction roof rail, at least one middle transverse direction roof rail, and a rear transverse direction roof rail of the transverse direction roof rails along the front-rear direction of the vehicle body.

The reinforcement member may be connected to the cross joint portion of the at least one middle transverse direction roof rail and the longitudinal direction roof rails.

The longitudinal direction roof rails may be connected to the lower portion of at least one middle transverse direction roof rail among the transverse direction roof rails.

The longitudinal direction roof rails may be connected to a transverse direction side flange and a transverse direction rail forming part formed on the at least one middle transverse direction roof rail.

The longitudinal direction roof rails may include a joint forming part formed at each end facing each other along the front-rear direction of the vehicle body to be connected with the transverse direction side flange and the transverse direction rail forming part.

The transverse direction roof rails may include at least one middle transverse direction roof rail, and at least one middle transverse direction roof rail may include a transverse direction side flange formed on each side along the front-rear direction of the vehicle body, a transverse direction rail forming part formed downward from the transverse direction side flange, and concave forming beads and convex forming beads alternately formed along the vehicle width direction on the transverse direction side flange.

The longitudinal direction roof rails may be connected to the lower portion of the convex forming beads.

The at least one middle transverse direction roof rail may include transverse direction sealer application grooves formed along the vehicle width direction in the convex forming beads.

The longitudinal direction roof rails may include a longitudinal direction side flange formed on each side along the vehicle width direction, a longitudinal direction rail forming part formed downward from the longitudinal direction side flange, and longitudinal direction sealer application grooves formed spaced apart along the front-rear direction of the vehicle body on the longitudinal direction side flange.

The roof panel may include roof beads formed in shapes corresponding to the concave forming beads and convex forming beads.

The reinforcement member may be connected to the upper portion of at least one middle transverse direction roof rail at the cross joint portion of the at least one middle transverse direction roof rail among the transverse direction roof rails and the longitudinal direction roof rails.

The reinforcement member may be connected to a transverse direction side flange and a transverse direction rail forming part formed on at least one middle transverse direction roof rail at the cross joint portion of the at least one middle transverse direction roof rail among the transverse direction roof rails and the longitudinal direction roof rails.

The reinforcement member may include a joint flange formed on each side of the vehicle body along the front-rear direction of the vehicle body, connected to the convex forming beads formed on the transverse direction side flange and the longitudinal direction side flange formed on the longitudinal direction roof rails.

The reinforcement member may further include reinforcement forming parts formed on both sides along the vehicle width direction with a flat surface connected to the joint flange, and connected to the transverse direction rail forming part.

The reinforcement member may further include joint sealer application grooves formed on the joint flange and the flat surface.

A closed cross-section may be formed between the reinforcement member and the at least one middle transverse direction roof rail intersecting in the vertical direction by the joint flange, the flat surface, and the reinforcement forming parts.

The transverse direction roof rails may include a rear transverse direction roof rail, and the roof structure may further include at least one extension roof rail connected to the rear transverse direction roof rail.

By using a roof structure according to some embodiments, the bonding strength of large-area roof panels can be strengthened and the sagging problem of roof rails can be suppressed.

A roof structure according to some embodiments can be applied to vehicle bodies of various vehicle types, thereby reducing development time and investment costs.

Advantages that can be obtained or expected from the disclosed example embodiments are disclosed directly or implicitly in the detailed description of the present disclosure. That is, various advantages expected according to the disclosed example embodiments will be disclosed in the detailed description that follows.

### BRIEF DESCRIPTION OF THE DRAWINGS

The drawings are intended for reference in describing example embodiments of the present disclosure, and therefore technical ideas of the disclosed example embodiments should not be construed as necessarily limited to the accompanying drawings.

FIGS. 1 and 2 are exploded perspective views illustrating roof structures according to various example embodiments.

FIG. 3 is a top plan view illustrating a roof structure according to an example embodiment.

FIG. 4 is an exploded perspective view of a transverse direction roof rail and a longitudinal direction roof rail configured to be applied to a roof structure according to an example embodiment.

FIGS. 5A and 5B are perspective views illustrating combined structures of a transverse direction roof rail and a longitudinal direction roof rail configured to be applied to a roof structure according to various example embodiments.

FIG. 6 is a perspective view illustrating a reinforcement member joining structure of a roof structure according to an example embodiment.

FIG. 7 is an exploded perspective view illustrating a reinforcement member joining structure of a roof structure according to an example embodiment.

FIG. 8 is a cross-sectional view along line A-A of FIG. 3.

FIG. 9 is a cross-sectional view along the B-B line of FIG. 3.

FIG. 10 is a cross-sectional view along the C-C line of FIG. 3.

FIG. 11 is a cross-sectional view along line D-D of FIG. 3.

FIG. 12 is a top plan view illustrating a roof structure according to an example modified embodiment.

The drawings referenced above are not necessarily drawn to scale, and may be understood as presenting rather simplified representations of various features that illustrate some principles of some example embodiments. For example, certain design features of the disclosed embodiments, including specific dimensions, direction, position, and shape, may be determined in part by the particular intended application and usage environment.

### DETAILED DESCRIPTION OF ILLUSTRATIVE EMBODIMENTS

Hereinafter, with reference to the attached drawings, example embodiments of the present disclosure will be described in detail so that a person having ordinary skill in the art to which the present disclosure pertains can easily practice embodiments of the present disclosure. As those skilled in the art may realize, the described example embodiments may be modified and combined in various different ways for other embodiments, without departing from the spirit or scopes of the present disclosure.

Terminology used herein is for the purpose of describing particular example embodiments and is not intended to necessarily limit the present disclosure. As used herein, singular forms may be intended to include plural forms as well, unless the context clearly indicates otherwise.

It should also be understood that the terms “comprise” and/or “include” as used herein indicate the presence of stated features, integers, steps, operations, elements and/or components, but do not preclude the presence or addition of one or more other features, integers, steps, operations, components, and/or groups thereof. As used herein, the term “and/or” includes any and all combinations of one or more of the associated listed items.

In this specification, the term “connected” indicates a physical relationship between two components where the components are directly connected to each other by welding, SPR (Self Piercing Rivet), FDS (Flow Drill Screw), structural adhesive, etc., or indirectly connected through one or more intermediate components.

As used herein, “vehicle”, “vehicular”, “automotive” or other similar terms as used herein may generally refer to passenger vehicles, sports cars, sport utility vehicles (SUVs), buses, trucks, tractors, and various commercial vehicles including passenger automobiles, hybrid vehicles, electric vehicles, hybrid electric vehicles, electric vehicle-based PBVs (Purpose Built Vehicles), hydrogen-powered vehicles and other alternative fuel vehicles (e.g., other than petroleum fuel derived from resources), for example.

Hereinafter, some example embodiments of the present disclosure will be described in detail with reference to the attached drawings.

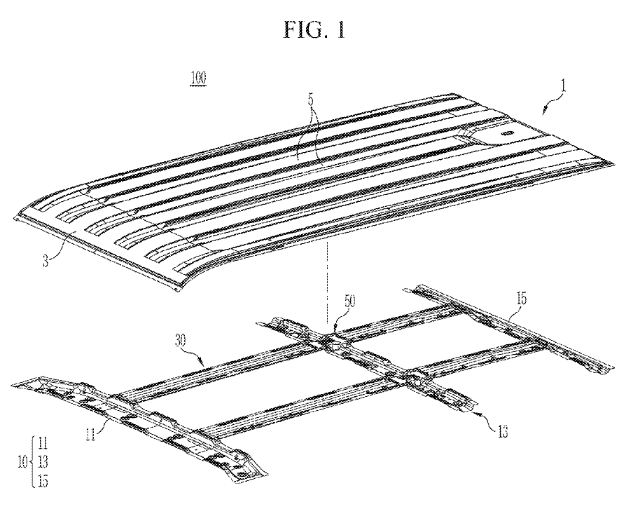

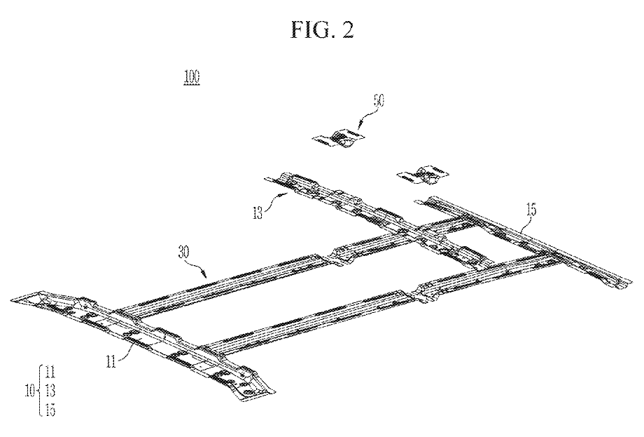

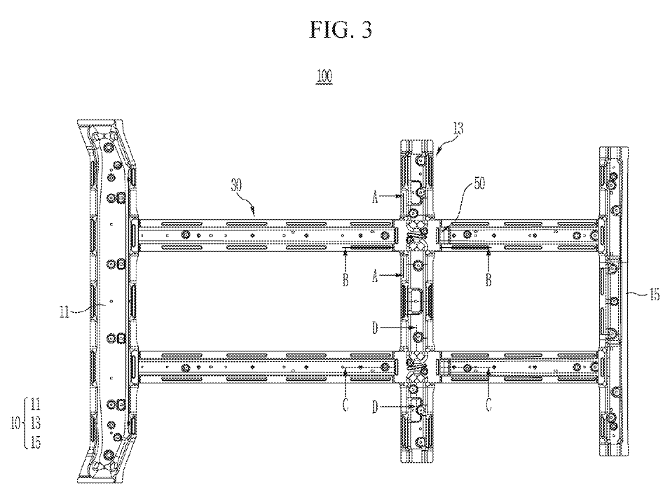

FIGS. 1 and 2 are exploded perspective views illustrating roof structures according to various example embodiments. FIG. 3 is a top plan view illustrating a roof structure according to an example embodiment.

Referring to FIGS. 1-3, a roof structure 100 according to an example embodiment can be applied, for example, to a vehicle body of a purpose-based mobility vehicle (Purpose Built Vehicle: hereinafter referred to as “PBV”).

The PBV may be utilized as an electric vehicle-based life module vehicle that provides various customized services to users during the time they travel from the departure point to the destination.

In one example, the PBV may be manufactured as a one box type design with a wide vehicle interior space. The PBV may also apply facing-type seats to the vehicle interior space. The vehicle body of the PBV may be manufactured in various shapes and sizes depending on the purpose of use of the PBV.

The vehicle body of the PBV may be utilized as a variety of vehicle types, such as a hailing vehicle as a means of transporting occupants, a delivery vehicle for transporting goods, and a special vehicle such as an ambulance, for example.

In this specification, the reference direction for describing the components below may be set as the vehicle body front-back direction (e.g., vehicle body length direction or longitudinal direction), vehicle width direction (e.g., lateral direction or left-right direction), and vertical direction (e.g., height direction) with the vehicle body as reference.

In this specification, the “top”, “upper”, or “upper face” of a component refers to an end, section, or face of the component that is relatively higher in the drawing, and the “bottom”, “lower”, or “lower face” of a component refers to an end, section, or face of the component that is relatively lower in the drawing.

In this specification, the term “end” of a component (e.g., one end, the other end, or both ends, etc.) refers to an end of the component in any one direction, and the term “end portion” of a component (e.g., one end portion, the other end portion, both end portions, the front end portion, or the rear end portion, etc.) refers to a portion of the component that includes that end.

A roof structure 100 according to an example embodiment can be mounted on an upper portion of a side structure disposed on each side of the vehicle body. Roof structure 100 may include a large area roof panel 1 to provide the user with a wide vehicle interior space.

In some embodiments, the side structure may be designed to form a cabin or luggage room (or cargo room) of a wide vehicle interior space inside the vehicle body. In some embodiments, the side structure may include doors and windows, etc., depending on the required configuration depending on the type of vehicle.

For example, the side structure may be equipped with vehicle doors such as sliding doors and swing doors. The side structure may be equipped with an openable window or fixed glass, or may not have a window mounted, depending on the vehicle type.

The roof structure 100 according to an example embodiment can reinforce the bonding strength of a large area roof panel 1 and provide a structure applicable to vehicle bodies of various vehicle types.

The roof structure 100 according to an example embodiment may include transverse direction roof rails 10, longitudinal direction roof rails 30, and reinforcement members 50.

In an example embodiment, the transverse direction roof rails 10 are disposed along the vehicle width direction and can be connected to the lower portion of the large area roof panel 1. The transverse direction roof rails 10 can be connected to the upper portion of the side structure along the vehicle width direction.

The roof panel 1 may, in one example, be provided with one panel, and in another example, may be provided with at least two panels. The roof panel 1 may include a slope portion 3 that slopes downwards at the front side. The roof panel 1 can be equipped with PBV’s operational modules, such as sensor and antenna function components.

The transverse direction roof rails 10 may include a front transverse direction roof rail 11, at least one middle transverse direction roof rail 13, and a rear transverse direction roof rail 15.

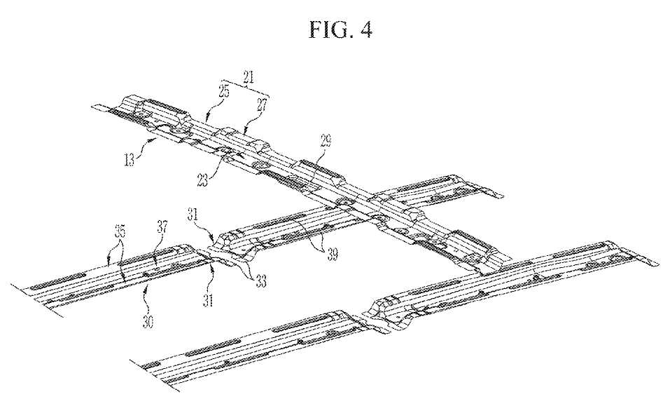

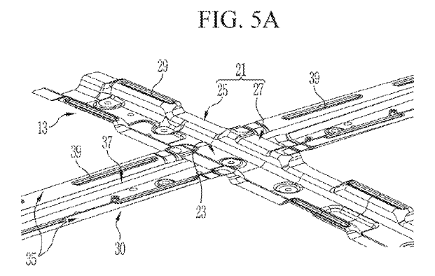

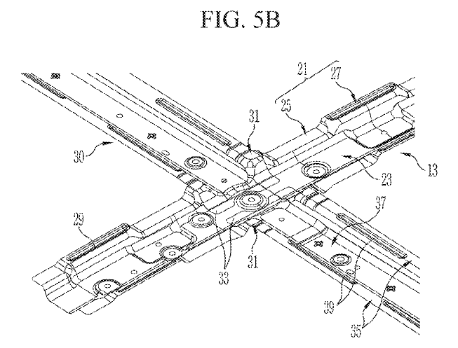

FIG. 4 is an exploded perspective view of a transverse direction roof rail and a longitudinal direction roof rail configured to be applied to a roof structure according to an example embodiment. FIGS. 5A and 5B are perspective views illustrating combined structures of a transverse direction roof rail and a longitudinal direction roof rail configured to be applied to a roof structure according to an example embodiment.

Referring to FIGS. 4-5B, in an example embodiment, the at least one middle transverse direction roof rail 13 may include a transverse direction side flange 21 and a transverse direction rail forming part 23.

The transverse direction side flange 21 can be formed on each side of the middle transverse direction roof rail 13 along the front-rear direction of the vehicle body. The transverse direction rail forming part 23 can be formed into a shape formed downward from the transverse direction side flange 21.

The middle transverse direction roof rail 13 may further include concave forming beads 25 and convex forming beads 27 formed on the transverse direction side flange 21.

The concave forming beads 25 and the convex forming beads 27 can be formed alternately along the vehicle width direction on the transverse direction side flange 21. The roof panel 1 includes roof beads 5 (see FIG. 1) formed in concave and convex shapes corresponding to the concave forming beads 25 and the convex forming beads 27.

The middle transverse direction roof rail 13 may include transverse direction sealer application grooves 29 formed along the vehicle width direction in the convex forming beads 27.

Referring to FIGS. 1-3, in an example embodiment, the longitudinal direction roof rails 30 are connected to the transverse direction roof rails 10 along the front-rear direction of the vehicle body and can be connected to the lower portion of the roof panel 1.

The longitudinal direction roof rails 30 can be connected to the front transverse direction roof rail 11 at least one middle transverse direction roof rail 13, and the rear transverse direction roof rail 15 of the transverse direction roof rails 10 along the front-rear direction of the vehicle body.

The longitudinal direction roof rails 30 can be disposed in the form of two rows of spines along the front-rear direction of the vehicle body, for example. At least one middle transverse direction roof rail 13 and the longitudinal direction roof rails 30 may be disposed to cross in the vertical direction (vehicle body front-rear direction and vehicle width direction, or cross direction).

Referring to FIGS. 4-5B, he longitudinal direction roof rails 30 may be connected to the lower portion of at least one middle transverse direction roof rail 13.

The longitudinal direction roof rails 30 can be connected to the transverse direction side flange 21 of at least one middle transverse direction roof rail 13 and the transverse direction rail forming part 23. The longitudinal direction roof rails 30 can be connected to the convex forming beads 27 of the transverse direction side flange 21 and the transverse direction rail forming part 23.

At the cross point of the middle transverse direction roof rail 13 and the longitudinal direction roof rails 30, the longitudinal direction roof rails 30 can be disposed spaced apart from each other along the front-rear direction of the vehicle body. The facing spaced end of the longitudinal direction roof rails 30 can be defined as the free end 31.

The longitudinal direction roof rails 30 may include a joint forming part 33 formed at each of the free ends 31 facing each other. The joint forming part 33 can be connected to the convex forming beads 27 and the transverse direction rail forming part 23 of at least one middle transverse direction roof rail 13.

The longitudinal direction roof rails 30 may include a longitudinal direction side flange 35 and a longitudinal direction rail forming part 37.

The longitudinal direction side flange 35 can be formed on each side of the longitudinal direction roof rails 30 along the vehicle width direction. The longitudinal direction rail forming part 37 can be formed into a shape formed downward from the longitudinal direction side flange 35.

The longitudinal direction roof rails 30 may include longitudinal direction sealer application grooves 39 formed spaced apart along the vehicle body front-rear direction on the longitudinal direction side flange 35.

Referring to FIGS. 1-3, in some embodiments, the reinforcement member 50 is configured to reinforce the joint strength of transverse direction roof rails 10 and longitudinal direction roof rails 30 that are joined to the roof panel 1.

In some embodiments, the reinforcement member 50 is configured to reinforce the connection of cross joint portions 41 of the transverse direction roof rails 10 and longitudinal direction roof rails 30 that are joined to each other.

The reinforcement member 50 can be connected to the cross joint portion 41 of the middle transverse direction roof rail 13 and the longitudinal direction roof rails 30. The reinforcement member 50 can be connected to the upper portion of at least one middle transverse direction roof rail 13 at the cross joint portion 41.

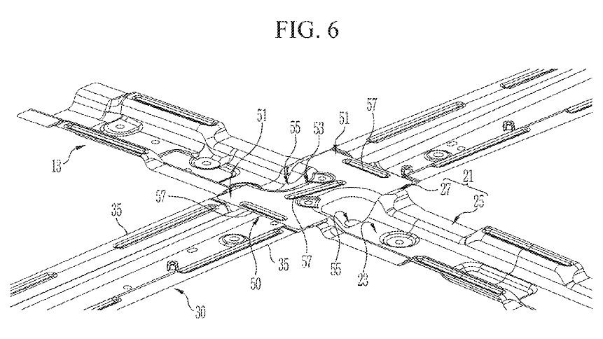

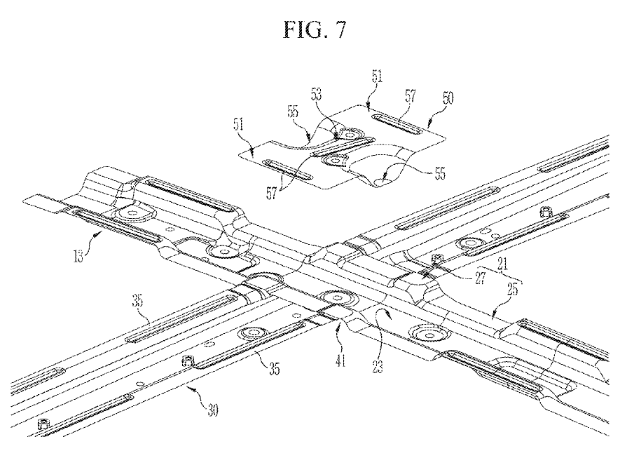

FIG. 6 is a perspective view illustrating a reinforcement member joining structure of a roof structure according to an example embodiment. FIG. 7 is an exploded perspective view illustrating a reinforcement member joining structure of a roof structure according to an example embodiment.

Referring to FIGS. 6 and 7, the reinforcement member 50 according to some embodiments can be connected to the convex forming beads 27 of the transverse direction side flange 21 and to the transverse direction rail forming part 23 on the upper portion of at least one middle transverse direction roof rail 13.

The reinforcement member 50 can be connected to the longitudinal direction side flange 35 on the upper portion of the longitudinal direction roof rails 30.

The reinforcement member 50 may include a joint flange 51, a flat surface 53, and reinforcement forming parts 55.

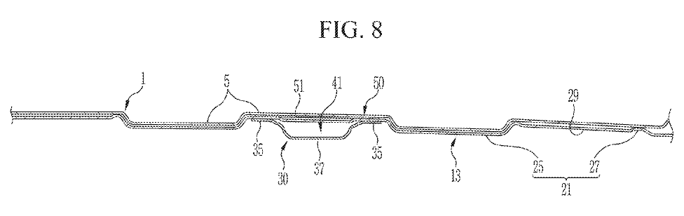

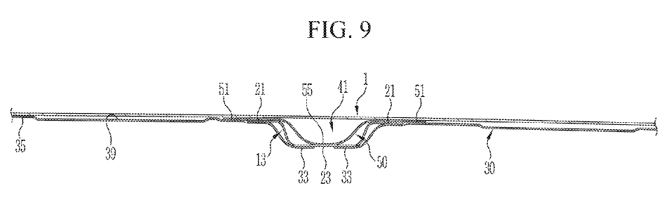

FIG. 8 is a cross-sectional view along line A-A of FIG. 3, and FIG. 9 is a cross-sectional view along the B-B line of FIG. 3.

Referring to FIGS. 6-9, the joint flange 51 can be formed on each side of the reinforcement member 50 along the front-rear direction of the vehicle body.

The joint flange 51 can be connected to the convex forming beads 27 of the transverse direction side flange 21 and the longitudinal direction side flange 35 of the longitudinal direction roof rails 30.

The flat surface 53 can be provided as the upper surface of the reinforcement member 50. The flat surface 53 can be connected to the joint flange 51.

The reinforcement forming parts 55 can be formed on both sides along the vehicle width direction with the flat surface 53 between them.

The reinforcement forming parts 55 can be formed into a shape that is formed downwardly on both sides of the flat surface 53. The reinforcement forming parts 55 can be connected to the transverse direction rail forming part 23 of at least one middle transverse direction roof rail 13.

The reinforcement member 50 may include joint sealer application grooves 57 formed on the joint flange 51 and the flat surface 53.

The joint sealer application grooves 57 may be formed along the vehicle width direction on the joint flange 51 and may be formed diagonally on the flat surface 53 along the vehicle body front-rear direction.

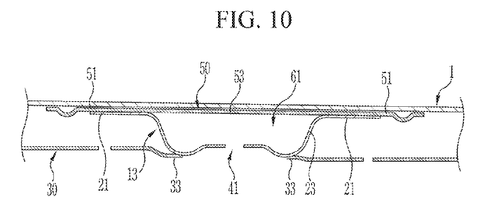

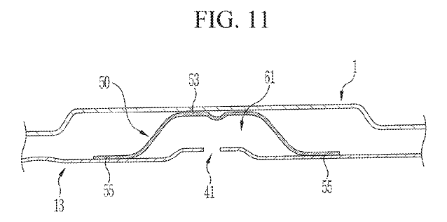

FIG. 10 is a cross-sectional view along the C-C line of FIG. 3, and FIG. 11 is a cross-sectional view along line D-D of FIG. 3.

Referring to FIGS. 6, 7, 10 and 11, a closed cross-section 61 intersecting in the vertical direction can be formed between the reinforcement member 50 and at least one middle transverse direction roof rail 13 joined to each other.

The closed cross-section 61 can be formed in a vertical direction intersecting along the vehicle body front-rear direction and the vehicle width direction by the joint flange 51, the flat surface 53, and the reinforcement forming parts 55.

The closed cross-section 61 can be formed along the front-rear direction of the vehicle body between the joint flange 51 and the flat surface 53 of the reinforcement member 50, and the transverse direction rail forming part 23 of at least one middle transverse direction roof rail 13 as shown in FIG. 10.

As shown in FIG. 11, the closed cross-section 61 can be formed along the vehicle width direction between the flat surface 53 of the reinforcement member 50 and the reinforcement forming parts 55, and the transverse direction rail forming part 23 of at least one middle transverse direction roof rail 13.

Hereinafter, an assembly process and operations of the roof structure 100 according to some embodiments configured as described above will be described in detail referring to FIGS. 1-11.

In an example embodiment, the front transverse direction roof rail 11, the at least one middle transverse direction roof rail 13, the rear transverse direction roof rail 15, the longitudinal direction roof rails 30, and the reinforcement member 50 may be provided.

In an example embodiment, a process of joining the longitudinal direction roof rails 30 to the front transverse direction roof rail 11 and the rear transverse direction roof rail 15 along the front-rear direction of the vehicle body can be performed.

In some embodiments, the free ends 31 of the longitudinal direction roof rails 30 connected to the front transverse direction roof rail 11 and the rear transverse direction roof rail 15 can be disposed spaced apart from each other along the front-rear direction of the vehicle body. In some embodiments, the joint forming part 33 is formed at each of the free ends 31 facing each other. In this state, a process of joining the at least one middle transverse direction roof rail 13 to the longitudinal direction roof rails 30 along the vehicle width direction can be performed.

In the above process, at least one middle transverse direction roof rail 13 can be placed on the joint forming part 33 of the longitudinal direction roof rails 30. The convex forming beads 27 of at least one middle transverse direction roof rail 13 and the transverse direction rail forming part 23 can be connected to the joint forming part 33.

A process can be performed to attach the reinforcement member 50 to the cross joint portion 41 of at least one middle transverse direction roof rail 13 and longitudinal direction roof rails 30 that are joined to each other.

In the above process, the reinforcement member 50 can be placed on the convex forming bead 27 and the transverse direction rail forming part 23 of at least one middle transverse direction roof rail 13 disposed on the longitudinal direction roof rails 30 on the cross joint portion 41.

The joint flange 51 of the reinforcement member 50 can be connected to the convex forming beads 27 and the longitudinal direction side flange 35 of the longitudinal direction roof rails 30. The reinforcement forming parts 55 of the reinforcement member 50 can be connected to the transverse direction rail forming part 23.

After going through this process, a process of joining the front transverse direction roof rail 11, in which the longitudinal direction roof rails 30 and the reinforcement member 50 are combined, at least one middle transverse direction roof rail 13, and the rear transverse direction roof rail 15 to the upper portion of the vehicle body can be performed.

Both ends of the front transverse direction roof rail 11, at least one middle transverse direction roof rail 13, and the rear transverse direction roof rail 15 in the vehicle width direction can be connected to the roof side of the vehicle body.

A process may be performed to apply sealer (not shown) to the transverse direction sealer application grooves 29 of at least one middle transverse direction roof rail 13, the longitudinal direction sealer application grooves 39 of the longitudinal direction roof rails 30, and the joint sealer application grooves 57 of the reinforcement member 50. In some embodiments, sealer is also applied to the upper portion of the front transverse direction roof rail 11 and the rear transverse direction roof rail 15.

A process of joining the roof panel 1 to the front transverse direction roof rail 11, at least one middle transverse direction roof rail 13, the rear transverse direction roof rail 15, the longitudinal direction roof rails 30, and the upper portion of the reinforcement member 50 using a sealer can be performed.

The roof beads 5 of the roof panel 1 can be disposed at positions corresponding to the concave forming beads 25 and convex forming beads 27 of at least one middle transverse direction roof rail 13.

In some embodiments, the process described so far can be performed as a process for assembling the roof structure 100 on the upper portion of a vehicle body in a vehicle body assembly line. However, in some embodiments, without being limited thereto, a process of mounting the roof structure 100 assembled separately in a roof assemble line onto the upper portion of the vehicle body in a vehicle body assemble line may also be performed.

In some embodiments, for a roof structure 100 assembled through the processes described above, the reinforcement member 50 is connected to the cross joint portion 41 of at least one middle transverse direction roof rail 13 and the longitudinal direction roof rails 30.

The cross-sections of the middle transverse direction roof rail 13 and the reinforcement member 50 can be disposed within the cross-section of the longitudinal direction roof rails 30. The longitudinal direction roof rails 30, the middle transverse direction roof rail 13 and the reinforcement member 50 can be connected to each other by three layers of connecting cross-sections.

In some embodiments, the concave forming beads 25 and the convex forming beads 27 may be formed alternately on the transverse direction side flange 21 of the middle transverse direction roof rail 13.

In some embodiments, the middle transverse direction roof rail 13 may be formed as a discontinuous cross-section structure along the vehicle width direction by the concave forming beads 25 and the convex forming beads 27.

In some embodiments, the closed cross-section 61 may be formed between the reinforcement member 50 and the middle transverse direction roof rail 13, which intersects in the vertical direction.

Accordingly, for a roof structure 100 according to an example embodiment, the cross-section connectivity for the cross joint portion of the transverse direction roof rails 10 and the longitudinal direction roof rails 30 can be strengthened.

For a roof structure 100 according to an example embodiment, the overall strength of the roof rail assembly, in which the transverse direction roof rails 10 and longitudinal direction roof rails 30 are combined, can be reinforced through the reinforcement member 50.

For a roof structure 100 according to an example embodiment, the joint strength of the roof rail assembly and the large area roof panel 1 can be strengthened, and the sagging problem of the roof rail assembly can be suppressed.

For a roof structure 100 according to an example embodiment, load paths connected in multiple directions of the vehicle body front-rear direction and the vehicle width direction can be formed, so that the collision performance of the vehicle can be enhanced.

For a roof structure 100 according to an example embodiment, the sealer may be applied to the upper portion of the reinforcement member 50 in addition to the transverse direction side flange 21 of the middle transverse direction roof rail 13 and the longitudinal direction side flange 35 of the longitudinal direction roof rails 30.

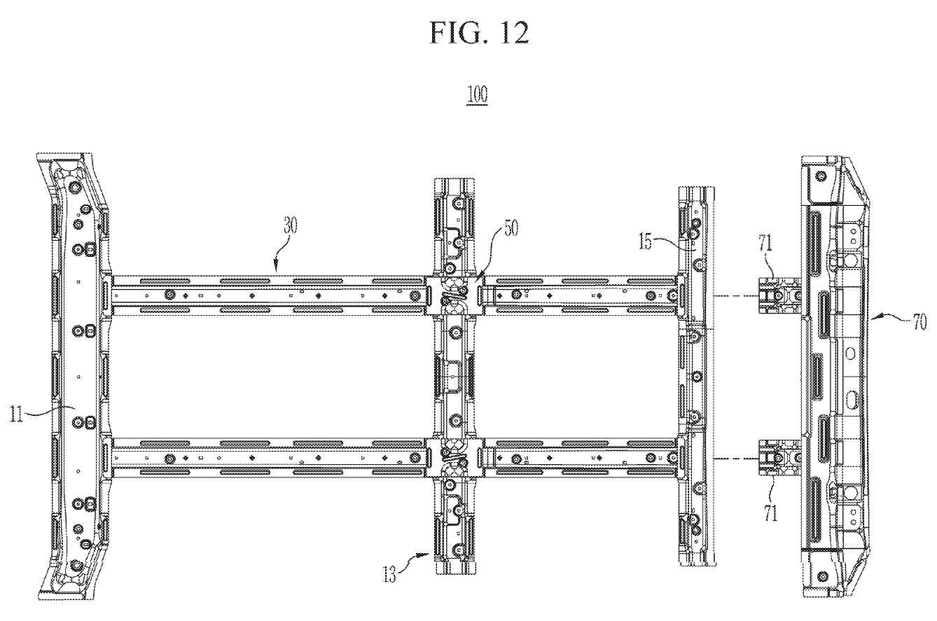

Therefore, for a roof structure 100 according to an example embodiment, the outer panel strength and NVH (noise, vibration, and harshness) performance of the large area roof panel 1 can be enhanced. FIG. 12 is a top plan view illustrating a roof structure according to the disclosed modified embodiment.

Referring to FIG. 12, a modified example of a roof structure 100 according to some embodiments may further include at least one extension roof rail 70.

In explaining the modified example of roof structure 100 according to the disclosed example embodiment, repeated explanations regarding the same/similar configuration as the roof structure according to the disclosed example embodiments described above are omitted.

A roof structure according to a modified example may include the front transverse direction roof rail 11, at least one middle transverse direction roof rail 13, the rear transverse direction roof rail 15, the longitudinal direction roof rails 30, and the reinforcement member 50 as described above.

In some embodiments, at least one extension roof rail 70 may be configured to selectively extend the rear portion of the roof structure 100 according to the vehicle body of various vehicle types.

In some embodiments, an extension roof rail 70 can be connected to the rear transverse direction roof rail 15 along the front-rear direction of the vehicle body.

In some embodiments, an extension roof rail 70 can be provided in various shapes and sizes according to vehicle bodies with different specifications. In some embodiments, an extension roof rail 70 can be connected to the rear transverse direction roof rail 15 via connecting members 71.

The roof structure 100 according to some embodiments can be applied to vehicle bodies of various specifications according to various use cases of the user, thereby reducing development time and investment costs.

While this present disclosure has been described in connection with what is presently considered to be some practical example embodiments, it may be understood that the present disclosure is not necessarily limited to the disclosed example embodiments. On the contrary, the present disclosure is intended to cover various modifications and equivalent arrangements included within the spirit and scopes of the appended claims and equivalents thereof.

What is claimed is:

1. A roof structure comprising:
a roof panel;
transverse direction roof rails connected to a lower portion of the roof panel and designed to be disposed along a vehicle width direction;
longitudinal direction roof rails connected to the transverse direction roof rails along a vehicle front-rear direction and connected to the lower portion of the roof panel; and
a reinforcement member connected to a cross joint portion of the transverse direction roof rails and the longitudinal direction roof rails.

2. The roof structure of claim 1, wherein the transverse direction roof rails comprise a front transverse direction roof rail, at least one middle transverse direction roof rail, and a rear transverse direction roof rail, and
wherein the longitudinal direction roof rails are connected to the front transverse direction roof rail, the at least one middle transverse direction roof rail, and the rear transverse direction roof rail of the transverse direction roof rails along the vehicle front-rear direction.

3. The roof structure of claim 2, wherein the reinforcement member is connected to the cross joint portion of the at least one middle transverse direction roof rail and the longitudinal direction roof rails.

4. The roof structure of claim 1, wherein the transverse direction roof rails comprise at least one middle transverse direction roof rail,
wherein the longitudinal direction roof rails are connected to a lower portion of the at least one middle transverse direction roof rail, and
wherein the at least one middle transverse direction roof rail comprises a transverse direction side flange and a transverse direction rail forming part, wherein the longitudinal direction roof rails are connected to the transverse direction side flange and the transverse direction rail forming part on the at least one middle transverse direction roof rail.

5. The roof structure of claim 4, wherein the longitudinal direction roof rails comprise a joint forming part at each end facing each other along the vehicle front-rear direction, wherein the joint forming part is connected with the transverse direction side flange and the transverse direction rail forming part.

6. The roof structure of claim 1, wherein the transverse direction roof rails comprise at least one middle transverse direction roof rail, and
wherein the at least one middle transverse direction roof rail comprises:
a transverse direction side flange on each side along the vehicle front-rear direction;
a transverse direction rail forming part disposed downward from the transverse direction side flange; and
concave forming beads and convex forming beads alternately disposed along the vehicle width direction on the transverse direction side flange.

7. The roof structure of claim 6, wherein the longitudinal direction roof rails are connected to a lower portion of the convex forming beads.

8. The roof structure of claim 6, wherein the at least one middle transverse direction roof rail comprises transverse direction sealer application grooves disposed along the vehicle width direction in the convex forming beads.

9. The roof structure of claim 8, wherein the longitudinal direction roof rails comprise:
a longitudinal direction side flange on each side along the vehicle width direction;
a longitudinal direction rail forming part disposed downward from the longitudinal direction side flange; and
longitudinal direction sealer application grooves disposed spaced apart along the vehicle front-rear direction on the longitudinal direction side flange.

10. The roof structure of claim 6, wherein the roof panel comprises roof beads in shapes corresponding to the concave forming beads and the convex forming beads.

11. The roof structure of claim 1, wherein the transverse direction roof rails comprise at least one middle transverse direction roof rail, and
wherein the reinforcement member is connected to an upper portion of the at least one middle transverse direction roof rail at the cross joint portion of the at least one middle transverse direction roof rail and the longitudinal direction roof rails.

12. The roof structure of claim 1, wherein the transverse direction roof rails comprise at least one middle transverse direction roof rail,
wherein the at least one middle transverse direction roof rail comprises a transverse direction side flange and a transverse direction rail forming part, and
wherein the reinforcement member is connected to the transverse direction side flange and the transverse direction rail forming part on the at least one middle transverse direction roof rail at the cross joint portion of the at least one middle transverse direction roof rail and the longitudinal direction roof rails.

13. The roof structure of claim 12, wherein the reinforcement member comprises a joint flange on each lateral side along the front-rear direction, connected to convex forming beads on the transverse direction side flange and a longitudinal direction side flange on the longitudinal direction roof rails.

14. The roof structure of claim 13, wherein the reinforcement member further comprises reinforcement forming parts on both sides along the vehicle width direction including a flat surface connected to the joint flange, and connected to the transverse direction rail forming part.

15. The roof structure of claim 14, wherein the reinforcement member further comprises joint sealer application grooves disposed on the joint flange and the flat surface.

16. The roof structure of claim 14, wherein a closed cross-section is between the reinforcement member and the at least one middle transverse direction roof rail intersecting in a vertical direction by the joint flange, the flat surface, and the reinforcement forming parts.

17. The roof structure of claim 1, wherein the transverse direction roof rails comprise a rear transverse direction roof rail, and
wherein the roof structure further comprises at least one extension roof rail connected to the rear transverse direction roof rail.

18. A modular vehicle comprising:
vehicle body of various vehicle types; and
a modular roof structure configured to fit the vehicle body, the modular roof structure comprising:
a roof panel;
transverse direction roof rails connected to a lower portion of the roof panel and disposed along a vehicle width direction,
longitudinal direction roof rails connected to the transverse direction roof rails along a vehicle front-rear direction and connected to the lower portion of the roof panel, and
a reinforcement member connected to a cross joint portion of the transverse direction roof rails and the longitudinal direction roof rails.

19. The modular vehicle of claims claim 18, wherein the transverse direction roof rails comprise a front transverse direction roof rail, at least one middle transverse direction roof rail, and a rear transverse direction roof rail, and
wherein the longitudinal direction roof rails are connected to the front transverse direction roof rail, the at least one middle transverse direction roof rail, and the rear transverse direction roof rail of the transverse direction roof rails along the vehicle front-rear direction, and
wherein the reinforcement member is connected to the cross joint portion of the at least one middle transverse direction roof rail and the longitudinal direction roof rails.

20. A method of assembling a vehicle, comprising:
assembling a roof frame including a front transverse direction roof rail, at least one middle transverse direction roof rail, a rear transverse direction roof rail, longitudinal direction roof rails, and reinforcement members, wherein the assembling of the roof frame comprises:
connecting the front transverse direction roof rail, the at least one middle transverse direction roof rail, and the rear transverse direction roof rail to the longitudinal direction roof rails, and forming cross joint portions where the at least one middle transverse direction roof rail overlaps with the longitudinal direction roof rails, and
connecting the reinforcement members onto the cross joint portions, and
connecting the roof panel to the roof frame to form a roof structure; and
before or after the connecting of the roof panel to the roof frame, connecting the roof structure to upper portions of a vehicle body of the vehicle.
